(19) United States
(12) Patent Application Publication
(10) Pub. No.: US 2023/0034491 A1
(43) Pub. Date: Feb. 2, 2023

(54) FITTED FACE MASK APPARATUS

(71) Applicant: Paul Newman, Grants Pass, OR (US)

(72) Inventor: Paul Newman, Grants Pass, OR (US)

(73) Assignee: Lighthouse Worldwide Solutions, Inc., Medford, OR (US)

(21) Appl. No.: 17/816,263

(22) Filed: Jul. 29, 2022

Related U.S. Application Data
(60) Provisional application No. 63/227,165, filed on Jul. 29, 2021.

(51) Int. Cl. A41D 13/11

(52) U.S. Cl. CPC A41D 13/1123; A41D 13/1161

(57) ABSTRACT

A face mask apparatus equipped with specially positioned fabric welds configured to ensure that the face mask contours to the shape of a user's face snugly and securely when worn. The unique weld enables the face mask to be manufactured in differing sizes without changing the fit of the fabrics employed in the construction of the mask, expediting and simplifying production. The contour established via the specific placement of the welds is aided by a foam segment on a nose bridge portion configured to provide comfort as well as a secure seal on all borders of the face mask. Three panels of varying sizes are present on each fit of the face mask.

This application is a non-provisional patent application of provisional patent application No. 63/227,165, filed on Jul. 29, 2021, and priority is claimed thereto.

### FIELD OF THE PRESENT INVENTION

The present invention relates to the field of personal protective equipment as used in the medical profession and others to prevent bacteria, viruses, dust, and debris from entering the respiratory system, and more specifically relates to a new form of face mask equipped with specially positioned fabric welds configured to ensure that the face mask contours to the shape of the user's face snugly and securely when worn. Additionally, the unique weld enables the face mask to be manufactured in differing sizes without changing the size of the fabrics employed in the construction of the mask, expediting and simplifying production.

### BACKGROUND OF THE PRESENT INVENTION

Personal protective gear (PPE) is known to include an assortment of items which are effective at minimizing the user's contact with potentially dangerous environments. The use of items such as masks, gloves, gowns, face shields, and the like are critical to the medical personnel conventionally known to be required to use such equipment in order to ensure that they remain healthy and able to treat new patients.

Unfortunately, face masks conventionally available today are mass produced in such as fashion as to be ‘one-size-fits-all.’ As with most products with this moniker, this is rarely the case, as there are plenty of users with a face too large or too small to readily wear a one-size-fits-all mask comfortably and safely. Due to the nature of the way in which they adhere and conform to the face of the user, in a one-size-fits-all fashion, the wearer's comfort is not optimized. This makes wearing face masks cumbersome, and can even lead to safety concerns or viral infection due to use of a poorly fitted face mask. If a mask is too large, it is generally loose in certain areas which allows airflow through to the individual's mouth and nose around the sides of the mask, limiting its utility by minimizing the filtration of air.

Some fitted masks have been made available on the market, however all of the presently available face masks employ adjustable wires which can be uncomfortable, and they are often not effective in retaining their position on the face when worn for a whole day. If there were a mask which could conform to the face, and which was manufactured in a one-size-fits-all fashion while being capable of being sized (small, medium, and large) during production via fabric welds which limit the aperture of the mask in accordance with the target fit, then more comfortable masks could be made easier at scale while fitting a larger range of individuals.

Thus, there is a need for a new form of face mask apparatus configured to conform to the face of the user by employing a special fabric weld and/or seam which enables the mask, when opened, to contort and adhere to the face in an optimal and comfortable fashion, ensuring the safety of the user. Such a mask is preferably produced in such a fashion as to exhibit a consistent overall size or dimension of material, which may then be shaped via the fabric welds to change the degree to which the mask opens, altering the aperture and fit to affect a change on the utility of the mask to correspond with differently sized faces of users. Additionally, such a face mask is preferably a three-panel mask with an enlarged nose panel to enable the mask to comfortably conform to the nose and cheeks of the user without pinching the nose.

### SUMMARY OF THE PRESENT INVENTION

The present invention is a face mask apparatus configured to conform to the face of a user while remaining affordable and easy to manufacture. Due to the ease of manufacturing, the face mask is available in multiple fits from the same size of fabric. The apparatus is equipped with two fabric welds or seams which differ in size and position in accordance with the target fit of the face mask (i.e. configured to fit a child vs. configured to fit an adult). The two fabric welds are present within the same piece of material, segmenting the material into three panels. When opened, the extent to which the mask may be opened is limited by the fabric welds, helping to provide an accurately sized face mask which retains conformity to the face for a proper fit.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the preferred embodiment of the face mask apparatus of the present invention as shown from the side.

FIG. 2 exhibits view of three sizes of the face mask apparatus of the present invention as shown from the rear, detailing the fabric welds sizes and positions which affect the overall size of the apparatus.

FIG. 3 shows a view of the face mask apparatus of the present invention as shown from the rear and side.

FIG. 4 depicts a view of the present invention as seen from the bottom.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

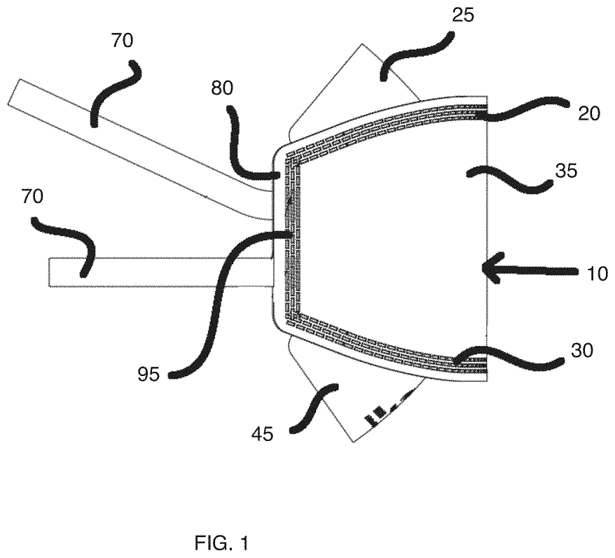

The present invention is a face mask (10) configured to be worn on the face of a user to prevent transmission of viruses and bacteria, as well as to minimize inhalation of dust and debris. The face mask (10) is equipped with a top fabric weld (20) and a bottom fabric weld (30). The size, placement, and angle of the top fabric weld (20) and bottom fabric weld (30) dictate the way in which it may conform to differently sized faces when opened and worn. Ultimately, the placement of the top fabric weld (20) and the bottom fabric weld (30) determine the extent to which the face mask (10) may be opened, thereby altering the fit of the face mask (10). The top fabric weld (20) and the bottom fabric weld (20) divide the face mask (10) into three panels: a top panel (25), a middle panel (35) and a bottom panel (45), as shown in FIG. 1.

The top panel (25) is configured to conform to the top half of the face of the user, covering the bridge of the nose and extending to the cheeks, below the eyes. The top panel (25) functions as a gasket panel, and provides a wider area of contact with the face of the user than a traditional disposable face mask, helping to reduce face fatigue from extended use. The top panel (25) is preferably equipped with a malleable support (55) which helps to ensure that the top panel (25) of the face mask (10) conforms to the bridge of the nose, and tapers to the tops of the cheeks, below the eyes of the user. The middle panel (35) is configured to rest over the mouth and nostrils of the user. The top fabric weld (20) preferably rests just below the nostrils of the user when worn correctly. The bottom panel (45), disposed below the middle panel (35), tapers inward towards the neck of the user, and is configured to rest snug against and/or beneath the jaw of the user.

The face mask (10) exhibits an aperture (40) on a rear (50) of the mask, and has a generally planar front (60). Retention straps (70) are preferably permanently affixed to the sides of the face mask (10) as seen in FIG. 1. The retention straps (70) are configured to ensure that the face mask (10) is firmly retained in the correct and safe position over the mouth and nose of the user when worn in a conventional manner.

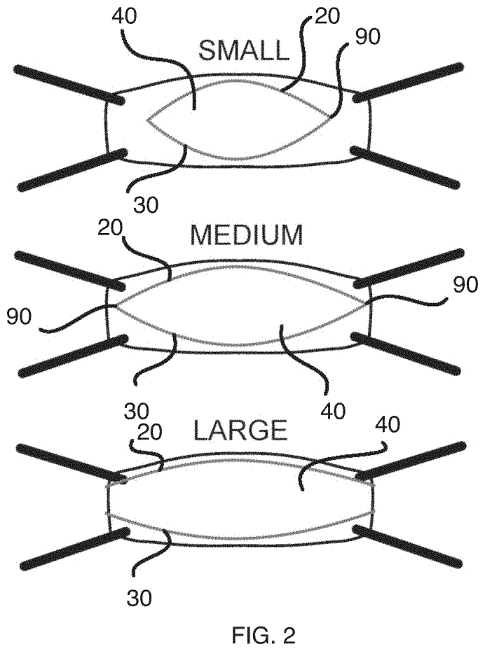

The top fabric weld (20) and bottom fabric weld (30) function together to limit the extent (height and width) of the opening, referenced as the aperture (40), of the face mask (10). When opened, the top fabric weld (20) and bottom fabric weld (30) of the face mask (10) are drawn taught, revealing the unfolded form of the mask as shown in FIG. 1. The top fabric weld (20) and bottom fabric weld (30) are preferably rigid in that they do not stretch by significant degree to ensure that the face mask (10) retains its shape during use. As such, if the user finds that the face mask (10) appears to not quite open far enough to fit his or her face, then he or she should opt to use a larger embodiment of the face mask (10) of the present invention. A larger embodiment is not actually any larger than other embodiments, but rather the top fabric weld (20) and bottom fabric weld (30) are positioned differently to affect the fit of the face mask (10) in accordance with the dimensions of the user's face as shown in FIG. 2. The dimensions of the nose of the user help to pull the sides (55) of the face mask together, helping the mask stay snug against the face of the user.

As shown in FIG. 2, the top fabric weld (20) and bottom fabric weld (30) are disposed in differing positions which are dependent upon the intended size of the face mask (10). The top fabric weld (20) and bottom fabric weld (30) of the small and medium embodiments of the face mask (10) meet near the retention straps (70), constricting the size of the aperture (40). However, the top fabric weld (20) and bottom fabric weld (30) of the large embodiment do not meet, but instead terminate at edges (80) of the face mask (10), providing a wider range of movement. As depicted in FIG. 2, the meeting points (90) of the top fabric weld (20) and bottom fabric weld (30) are closer together in the small embodiment than they are on the medium embodiment, facilitating the constriction of the aperture (40) when opened. In large embodiments, the meeting points (90) may be assisted via vertical fabric welds (95), connecting the top fabric weld (20) to the bottom fabric weld (30) at the sides of the face mask (10).

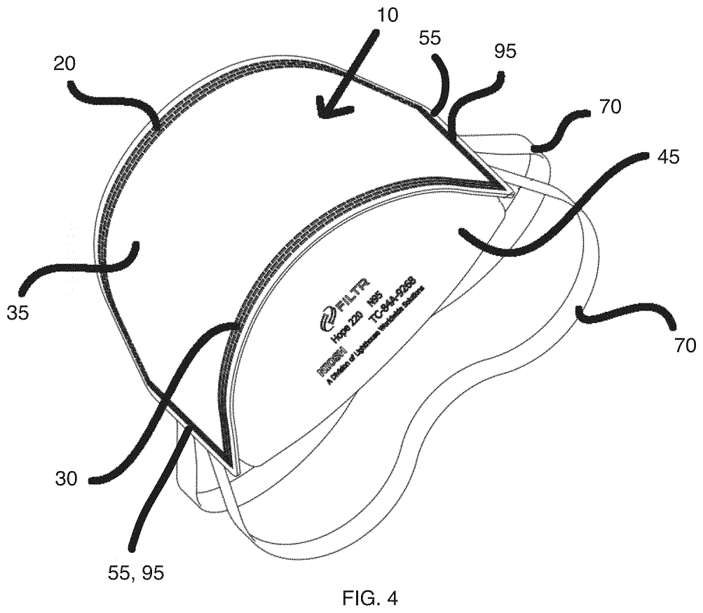

In the preferred embodiment of the present invention, a foam segment (85) is present on an interior of the top panel (25), beneath the malleable support (55) as shown in FIG. 4. The foam segment (85) is configured provide a comfortable fit while also ensuring a firm seal of the mask to the face of the user is created. The foam segment (85) is preferably held in place on the interior of the top panel (25) via conventional means such as adhesive.

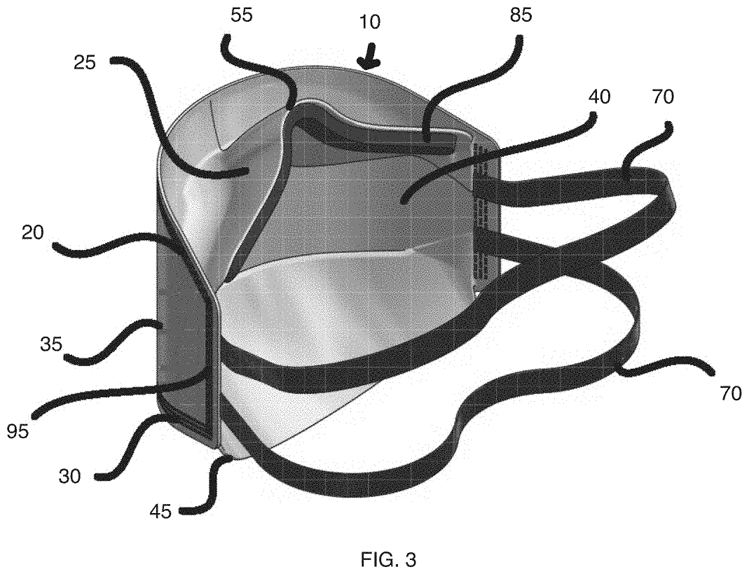

It should be understood that the face mask (10) of the present invention is static in material dimension. However, solely the fit of the mask is changed due to the placement of the top fabric weld (20) and bottom fabric weld (30). As shown in FIG. 2, the small embodiment exhibits placement of the top fabric weld (20) and bottom fabric weld (30) such that a mirrored, eye-shaped parabolic curve is presented, meeting at the meeting points (90) distant from the sides of the face mask (10), creating a small fit. In contrast, the medium embodiment employs a similar eye-shaped mirror parabolic curve of the top fabric weld (20) and bottom fabric weld (30), however the meeting points (90) are positioned very close to the sides of the mask, creating a medium fit. Finally, the large embodiment, as shown in FIGS. 1 and 3 as well, exhibits a top fabric weld (20) and bottom fabric weld (30) that do not meet, but instead are bridged by vertical fabric welds (95) present along the sides of the face mask (10) to create a large fit. Each the small, medium, and large fits are all fashioned of the same size of material.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A face mask apparatus comprising:
a top panel, said top panel having a top panel front portion and a top panel rear portion;
a middle panel, said middle panel disposed beneath said top panel;
wherein said middle panel has a middle panel front portion and a middle panel rear portion;
filters, said filters present between said middle panel front portion and said middle panel rear portion;
wherein said middle panel is segmented from said top panel via a top fabric weld;
a bottom panel, said bottom panel disposed beneath said middle panel;
wherein said bottom panel has a bottom panel front portion and a bottom panel rear portion;
wherein said bottom panel is segmented from said middle panel via a bottom fabric weld;
wherein said top panel, said middle panel, and said bottom panel are all of the same material;
wherein said top panel, said middle panel, and said bottom panel are permanently connected together;
two edges, said edges disposed on said top panel, said middle panel, and said bottom panel;
retention straps, said retention straps disposed in communication with said edges;
an aperture, said aperture disposed on said rear, bounded by said top panel and said bottom panel;
wherein said aperture has a height and a width which vary in accordance with a size of the face mask; and
wherein said width is bounded by said edges.

2. The apparatus of claim 1, wherein said top fabric weld and said bottom fabric weld limit said height and said width of said aperture proportionally; and
as said aperture opens, increasing said height, said width is decreased.

3. The apparatus of claim 2, wherein differing the placement of said top fabric weld and said bottom fabric weld alters the fit of the face mask by varying the extent to which the aperture may open.

4. The apparatus of claim 2, further comprising:
at least one malleable support, said at least one malleable support disposed within said top panel;
wherein said at least one malleable support extends across a majority of said top panel; and
wherein said at least one malleable support is centered on a width of said top panel.

5. The apparatus of claim 3, wherein differing the placement of said top fabric weld and said bottom fabric weld alters the fit of the face mask by varying the extent to which the aperture may open.

6. The apparatus of claim 3, further comprising:
at least one malleable support, said at least one malleable support disposed in fixed communication with said top panel;
wherein said at least one malleable support extends across a majority of said top panel; and
wherein said at least one malleable support is centered on a width of said top panel.
